(19) United States
(12) Patent Application Publication
(10) Pub. No.: US 2019/0082002 A1
(43) Pub. Date: Mar. 14, 2019

(54) MEDIA FILE SHARING METHOD, MEDIA FILE SHARING DEVICE, AND TERMINAL

(71) Applicant: HUAWEI TECHNOLOGIES CO.,LTD., Shenzhen (CN)

(72) Inventors: Xueyan Huang, Shenzhen (CN); Kangmin Huang, Shenzhen (CN); Jiali Fu, Shenzhen (CN)

(73) Assignee: HUAWEI TECHNOLOGIES CO.,LTD., Shenzhen (CN)

(21) Appl. No.: 16/188,250

(22) Filed: Nov. 12, 2018

Related U.S. Application Data
(63) Continuation of application No. PCT/CN2016/081906, filed on May 12, 2016.

(51) Int. Cl. H04L 29/08

(52) U.S. Cl. CPC H04L 67/06; H04L 67/1097

(57) ABSTRACT

A media file sharing method, a media file sharing device, and a terminal are provided. The media file sharing device determines a preset selection condition; selects, from a local file, a media file satisfying the preset selection condition as a to-be-shared media file; and shares the to-be-shared media file. Therefore, the to-be-shared media file does not need to be manually selected by a user, which can improve media file sharing efficiency.

### CROSS-REFERENCE TO RELATED APPLICATIONS

This application is a continuation of International Application No. PCT/CN2016/081906, filed on May 12, 2016, the disclosure of which is hereby incorporated by reference in its entirety.

### TECHNICAL FIELD

The present application relates to the field of communications technologies, and in particular, to a media file sharing method, a media file sharing device, and a terminal.

### BACKGROUND

With continuous development of communications technologies, functions of a mobile terminal have been increasingly enriched. For example, sharing a media file by using a social platform and viewing a media file shared by friends on a social platform have become an indispensable part of modern life.

Currently, when sharing a media file by using a social platform, a user needs to select a media file that meets a requirement from a large quantity of media files, and share the media file, for example, selecting media files that belong to a same scenario, a media file with relatively high definition, or the like to share.

At present, during sharing of a media file, a user needs to spend a relatively long time in selecting a media file to be shared, and therefore, sharing efficiency is relatively low.

### SUMMARY

Embodiments of the present application provide a media file sharing method, a media file sharing device, and a terminal, so as to improve sharing efficiency.

According to a first aspect, a media file sharing method is provided. In the method, a media file sharing device selects and shares a media file instead of manual selection by a user, so that media file selection during a media file sharing process is simplified, which can improve sharing efficiency.

The media file sharing device includes a terminal and a social platform.

In a possible design, the method includes: determining a preset selection condition; selecting, from a local file, a media file satisfying the preset selection condition as a to-be-shared media file; and sharing the to-be-shared media file. In this way, selecting the media file according to the preset selection condition and sharing the media file are implemented, which improves sharing efficiency.

The preset selection condition may include selecting a media file that has a preset association relationship with a current place of the media file sharing device. For example, a media file whose collection place is the same as a place of the media file sharing device may be selected, so that the media file sharing device can select, according to the current place of the media file sharing device, a media file matching the current place of the media file sharing device, and share the media file. Certainly, the preset selection condition may alternatively be selecting another media file that has a preset association relationship with a collection place. For example, a media file whose collection place is the same as a preset collection place is selected, so that the media file sharing device can select a media file satisfying the collection place that is set by a user.

The preset selection condition may alternatively include selecting a media file that has a preset association relationship with media file content. For example, a media file whose media file content has been processed may be selected, so that the media file sharing device selects a media file with relatively high quality of file content. For example, a media file in which a theme of media file content is the same as a preset theme may alternatively be selected, so that the media file sharing device can select a media file satisfying the theme that is set by a user. For example, a media file whose media file content is related to an external environment of the media file sharing device and a media file whose media file content is related to an event that occurs in the external environment of the media file sharing device may alternatively be selected, so that the media file sharing device selects a media file according to the current environment of the media file sharing device. For example, an associated media file associated with a selected to-be-shared media file may alternatively be selected. The associated media file includes at least one of the following: a media file whose background similarity with the selected to-be-shared media file exceeds a specified threshold; a media file whose subject has a same action as that of the selected to-be-shared media file; a media file whose subject has a same expression as that of the selected to-be-shared media file; or a media file whose subject has a same garment as that of the selected to-be-shared media file. When an associated media file is determined for the to-be-shared media file, there is generally one reference media file. If there is more than one selected media file, an associated media file may be determined for each media file.

The preset selection condition may alternatively include selecting a media file that has a preset association relationship with a collection time. For example, a media file whose collection time is in a preset collection time range may be selected, so that the media file sharing device can select a media file satisfying the collection time that is set by a user.

The preset selection condition may alternatively include selecting a media file matching a keyword in to-be-shared words of a user. For example, the media file sharing device may parse to-be-shared words of a user into keywords involving time and a place and keywords related to time and a task, and select a media file matching these keywords, so that the media file sharing device can select a media file according to the words shared by the user.

The preset sharing condition may be obtained by a user by selecting or modifying a sharing condition that is provided by the media file sharing device, so that the media file sharing device can select, according to a user instruction, a media file intended by the user.

In another possible design, after the selecting, from a local file, a media file satisfying the preset selection condition, the method further includes: when a quantity of selected media files exceeds a specified quantity, selecting, from the selected media files according to a priority sequence that indicates time intervals between collection time and a current time in ascending order, a media file whose quantity is less than or equal to the specified quantity. The specified quantity is less than or equal to a maximum quantity of media files that can be shared by the media file sharing device at a time, so that the media file sharing device can select a media file whose quantity satisfies a sharing quantity, where the media file for share is a media file that is collected in a latest time period.

In still another possible design, the media file sharing device shares the to-be-shared media file to at least one group based on a historical record of sharing a same media file to a group, to share one to-be-shared media file on multiple groups, thereby satisfying a requirement that a user in multiple groups should share one media file on another group of similar nature.

In yet another possible design, the media file sharing device parses content of the to-be-shared media file, and determines a word description matching the content of the to-be-shared media file; and the media file sharing device shares the to-be-shared media file and the word description matching the content of the to-be-shared media file. In this way, a process of entering a word description by a user is omitted, which improves sharing efficiency.

In yet another possible design, the media file sharing device may display, for share, the to-be-shared media file in one of the following two manners: displaying different media files respectively in different display areas on a media file sharing display interface, or displaying different media files in a same display area on a media file sharing display interface by means of scrolling.

In yet another possible design, before the media file sharing device shares the to-be-shared media file, when the media file sharing device detects a deletion instruction of a user for deleting a media file from the to-be-shared media file selected by the media file sharing device, the media file sharing device deletes, from the selected to-be-shared media file, the media file indicated by the deletion instruction. This is applicable to an application scenario in which a media file selected by the media file sharing device is not a media file that the user actually wants to share and the user needs to delete the selected to-be-shared media file.

After the deleting, from the selected to-be-shared media file, the media file indicated by the deletion instruction, the method further includes: when a media file that is added by the user is obtained, using a selected to-be-shared media file that is not deleted and the media file that is added by the user as to-be-shared media files. The media file that is added by the user may be a media file that is selected by the media file sharing device and that is recommended to the user. The media file that is selected by the media file sharing device and that is recommended to the user may be a media file associated with the deleted media file, or may be a media file that is selected by the media file sharing device and that is not used as a to-be-shared media file.

In yet another possible design, before sharing the to-be-shared media file, the media file sharing device receives a confirmation instruction for the user to confirm sharing of the to-be-shared media file, to provide manual confirmation for the user, thereby avoiding sharing a media file that the user does not want to share.

In yet another possible design, before selecting the to-be-shared media file, the media file sharing device receives a trigger operation used for triggering media file sharing. The trigger operation may be triggered by a user, may be triggered by a terminal that collects and stores a media file, or may be triggered by the social platform on which a media file is published. In this way, a flexible trigger manner for selecting a media file is implemented.

According to a second aspect, a media file sharing device is provided. The media file sharing device has all functions for implementing the foregoing media file sharing method. The functions may be implemented by means of hardware, or may be implemented by hardware executing corresponding software. The hardware or software includes one or more modules corresponding to the foregoing functions. The module may be software and/or hardware.

In a possible design, the media file sharing device includes a selection unit and a sharing unit. The selection unit is configured to: determine a preset selection condition; and select, from a local file, a media file satisfying the preset selection condition as a to-be-shared media file. The sharing unit is configured to share the to-be-shared media file selected by the selection unit.

In another possible design, the media file sharing device includes a processor and a communications interface. The processor is configured to support a corresponding function for performing the foregoing media file sharing method by the media file sharing device. The communications interface is configured to perform a communication function during a process of sharing the media file. The media file sharing device may further include a memory, where the memory is configured to be coupled to the processor, and the memory stores a program instruction and data that are required for the media file sharing device.

According to a third aspect, an embodiment of the present application further provides a computer storage medium, which is configured to store a computer software instruction used by the foregoing media file sharing device and includes a program used for the media file sharing device in the foregoing aspect.

According to the media file sharing method and the media file sharing device that are provided in the embodiments of the present application, a media file can be selected instead of manual selection by a user, which improves media file sharing efficiency.

### BRIEF DESCRIPTION OF DRAWINGS

FIG. 1 is a system architecture to which a media file sharing method can be applied according to an embodiment of the present application;

FIG. 2 is an internal structure diagram of a terminal that has a function for collecting and storing a media file according to an embodiment of the present application;

FIG. 3 is a flowchart of a media file sharing method according to an embodiment of the present application;

FIG. 4 is a schematic diagram of an interface for selecting and modifying a sharing condition by a user according to an embodiment of the present application;

FIG. 5A and FIG. 5B are schematic diagrams of graphical interfaces for sharing a media file on multiple groups according to an embodiment of the present application;

FIG. 6 is a flowchart of another implementation for sharing a media file by a terminal according to an embodiment of the present application;

FIG. 7 is a flowchart of still another implementation for sharing a media file according to an embodiment of the present application;

FIG. 8 shows a preview interface, provided for a user, for a selected to-be-shared media file according to an embodiment of the present application;

FIG. 9 is a schematic diagram of an interface, provided for a user, for a selected media file according to an embodiment of the present application;

FIG. 10 is a schematic diagram of an interface, provided for a user, for adding a media file according to an embodiment of the present application;

FIG. 11 is a schematic diagram of an interface for adding a media file according to an embodiment of the present application;

FIG. 12 is a flowchart of yet another implementation for sharing a media file according to an embodiment of the present application;

FIG. 13 is a schematic structural diagram of a media file sharing device according to an embodiment of the present application; and

FIG. 14 is another schematic structural diagram of a media file sharing device according to an embodiment of the present application.

### DESCRIPTION OF EMBODIMENTS

The following describes the technical solutions in the embodiments of the present application in detail with reference to the accompanying drawings in the embodiments of the present application.

An embodiment of the present application provides a method for selecting and sharing a media file by a media file sharing device instead of manual selection by a user, so that media file selection during a media file sharing process is simplified, which can improve sharing efficiency.

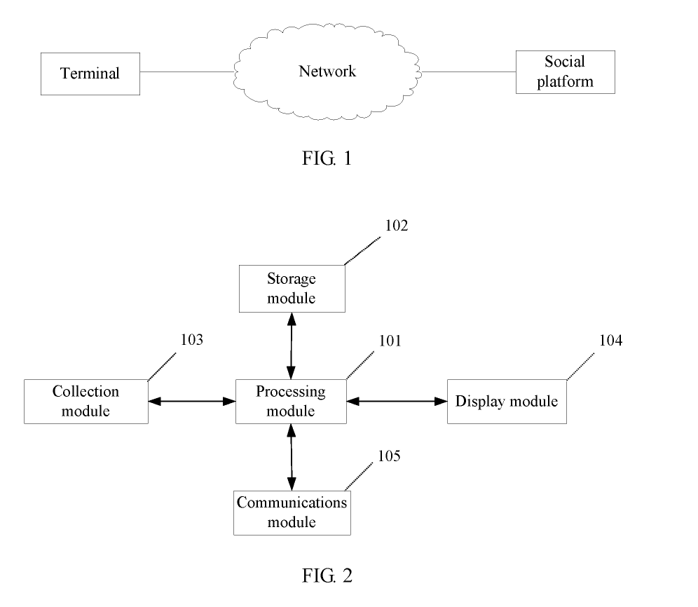

The media file sharing method provided in this embodiment of the present application can be applied to a system architecture shown in FIG. 1. In FIG. 1, a terminal has a function for collecting and storing a media file, and a social platform has a function for publishing a media file. A media file stored in the terminal is uploaded to the social platform by using a network, to be shared.

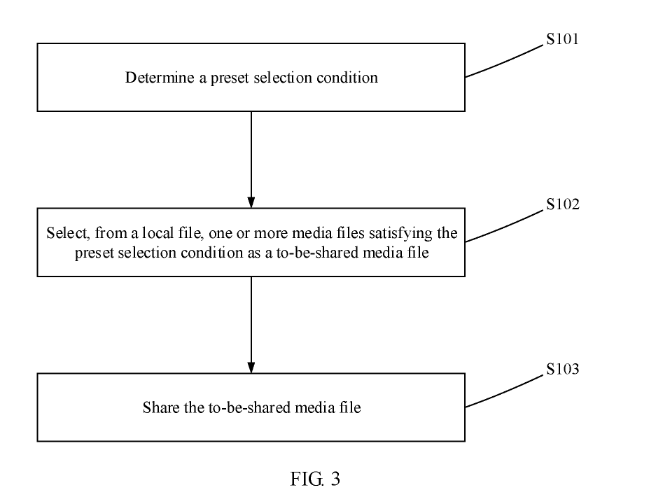

FIG. 2 is an internal structure diagram of a terminal that has a function for collecting and storing a media file according to an embodiment of the present application. In FIG. 2, a processing module 101 is configured to control hardware devices, application software, and the like of the terminal, and may be a central processing unit (CPU). A storage module 102 is configured to store various software programs of the terminal device, store data, run software, and the like, and may be one or more types of a random access memory (RAM), an erasable programmable read-only memory (Erasable Programmable Read-Only Memory, EPROM), a solid state drive (Solid State Drive, SSD), a secure digital (Secure Digital, SD) card, or a high definition (High Definition, HD) disk. A collection module 103 is configured to collect audio and video data, and other data, and may be a sensor device such as a camera and a microphone. A display module 104 is configured to display an operation screen and operation result of a user, and may receive data of the processing module and display the data. A communications module 105 is configured to communicate with another device, may receive, in a communication mode such as cellular, an Ethernet, Wireless Fidelity (Wireless Fidelity, WiFi), Bluetooth, or infrared, instruction information sent by the another device, and may also send data of the terminal to cloud or another device.

It should be noted that, the terminal in this embodiment of the present application may include a hand-held device, in-vehicle device, wearable device, or computing device that has various communication functions, or another processing device connected to a wireless modem, and may include user equipment (User equipment, UE), a mobile station (Mobile Station, MS), and terminal equipment (Terminal Equipment) of various forms, and the like. For example, the terminal in this embodiment of the present application may be a wearable device such as a smartphone, a watch, and glasses, may be a tablet computer that includes a camera, or may be an unmanned aerial vehicle or the like that has a photographing function. A social platform in this embodiment of the present application may be a client application that has a function for publishing a media file. The client application can be run on the terminal.

In this embodiment of the present application, a media file sharing device for selecting a media file may be the terminal, or may be the social platform. In this embodiment of the present application, that the media file sharing device is the terminal is used as an example for description in the following, but no limitation is imposed. For example, after being triggered to perform a function for sharing a media file, the social platform requests permission to view a media file on the terminal. The terminal grants, for the social platform, the permission to view a media file, and the social platform may also select a media file.

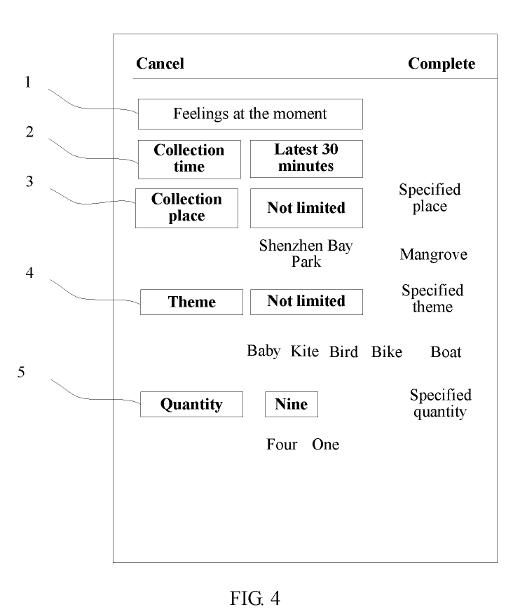

FIG. 3 is a flowchart of a media file sharing method according to an embodiment of the present application. The media file sharing method includes the following steps.

S101: Determine a preset selection condition.

The preset selection condition in this embodiment of the present application may include selecting a media file that has a preset association relationship with a current place of a media file sharing device, or may be selecting a media file that has a preset association relationship with media file content. It is unnecessary that there should be one type of preset selection condition in this embodiment of the present application. There may be one type of preset selection condition, or there may be a combination of multiple selection conditions.

S102: Select, from a local file, a media file satisfying the preset selection condition as a to-be-shared media file.

The local file in this embodiment of the present application includes a media file that is collected by a terminal and stored in the terminal, and also includes a media file that is obtained from another device or a network and temporarily stored in the terminal.

In this embodiment of the present application, one or more of the following manners may be used to select the media file satisfying the preset selection condition. In an implementable manner, a media file that is newly collected in a latest time period is selected as a to-be-shared media file according to collection time and places of media files. In another implementable manner, a media file matching a current external condition of the terminal is selected as a to-be-shared media file according to the current external condition of the terminal. In still another implementable manner, a media file matching a preset sharing condition is selected as a to-be-shared media file according to the preset sharing condition. In yet another implementable manner, an associated media file is selected as a to-be-shared media file according to relevance between media files. In still yet another implementable manner, a media file matching a keyword in to-be-shared words of a user is selected as a to-be-shared media file according to the words to be shared by the user on a social platform.

In this embodiment of the present application, the terminal uses the to-be-shared media file that is selected in any one of the foregoing implementation manners, where the to-be-shared media file is generally a media file of relatively high quality. For example, the media file of relatively high quality may be a media file without a jitter, a blur, a closed eye, a half-white face, or a red eye, and with proper brightness (for example, neither excessively dark nor excessively bright) and minimum background noise (for example, there is no background noise caused by a garbage box, a sign plate, an electric wire, or a passerby).

S103: A terminal shares the to-be-shared media file.

In this embodiment of the present application, the terminal may share the to-be-shared media file by using the social platform.

In this embodiment of the present application, the following describes, with reference to actual application, the foregoing process of selecting and sharing the to-be-shared media file by the terminal.

In this embodiment of the present application, the several implementation manners for selecting a to-be shared media file in the foregoing embodiment are first described separately.

(1) Select, according to collection time of media files, a media file that is newly collected in a latest time period as a to-be-shared media file.

In this embodiment of the present application, the terminal may identify the collection time of the media files. If the terminal detects that the terminal newly collects a media file, the terminal may be triggered to select and share the to-be-shared media file, so as to meet a user requirement for sharing the current media file.

In this embodiment of the present application, the terminal may identify, according to the collection time of the media files, the media file that is newly collected in the latest time period. In this embodiment of the present application, the latest time period may be a time value that is set by a user, or may be an empirical value that is set by the terminal by default. For example, the latest time period may be 30 minutes before a sharing moment.

In this embodiment of the present application, when selecting the media file that is newly collected in the latest time period as a to-be-shared media file, the terminal may identify, according to collection places of the media files, media files whose collection places are relatively concentrated as to-be-shared media files. That collection places are relatively concentrated refers to a case in which multiple media files are collected in a same collection place. For example, in the latest time period, a user shoots 30 photographs in a park, and shoots one photograph at home. In this case, the user is quite likely to share a photograph shot in the park, so as to share an event that the user has gone sightseeing in the park recently. The terminal detects that there are 30 media files whose collection places are the park and one media file whose collection place is home in the latest time period. Therefore, the terminal may select, from the 30 media files, some media files as to-be-shared media files.

In this embodiment of the present application, if detecting that there is only one media file in the latest time period, the terminal may directly use the media file as a to-be-shared media file. If detecting that there are multiple media files in the latest time period, the terminal may select, from the multiple media files, a media file of best quality or with the most distinct characteristic as a to-be-shared media file.

Specifically, the terminal may select a media file from multiple media files according to a media file theme, or may select a media file according to a sharing policy. For example, the terminal may select the first m media files whose collection time are close to a sharing moment, where m may be preset, a value of m may be any one of 1 to max, and max is a maximum value that is allowed by the social platform. The terminal may alternatively select a media file of best quality. Certainly, the terminal may alternatively select a media file with specific media content, for example, select a media file whose media content is a landscape or a person.

In this embodiment of the present application, a process of identifying a media file during selection of the to-be-shared media file may be implemented by using an image analysis algorithm, for example, image analysis, face detection, object detection, or content identification.

(2) Select, according to a current external condition of the terminal, a media file matching the current external condition of the terminal as a to-be-shared media file.

In this embodiment of the present application, the media file matching the current external condition of the terminal may be one or more of the following: a media file whose collection place is the same as a place of the terminal; a media file whose media file content is related to a place of the terminal; a media file whose media file content is related to an external environment of the terminal; or a media file whose media file content is related to an event that occurs in an external environment of the terminal. In this embodiment of the present application, the terminal selects the media file matching the current external condition of the terminal as a to-be-shared media file, so as to meet a user requirement for sharing a media file satisfying a current environment of the terminal.

In this embodiment of the present application, the terminal may detect the current external condition of the terminal by using a sensor, and select the media file matching the current external condition of the terminal. For example, if detecting, by using a global positioning system (Global Positioning System, GPS) of the terminal, that a current location is Shenzhen Bay, the terminal may select a media file related to Shenzhen Bay as a to-be-shared media file. The media file related to Shenzhen Bay may be a media file whose collection place is Shenzhen Bay or a media file in which a landscape in media file content is a landscape in Shenzhen Bay. The terminal may also detect an ambient environment by using a camera, to determine a user's current location, an activity that a user is participating in, and the like. For example, if detecting, by using a camera, that an external environment of a user is a scenario in which a party is being held in restaurant A, the terminal may select a media file that is related to restaurant A and whose scenario is that a party is being held, as a to-be-shared media file.

In this embodiment of the present application, during the process of selecting, by the terminal, the media file matching the current external condition of the terminal as a to-be-shared media file, if media file information, such as collection time and places, is recorded in media files, the terminal may directly select the to-be-shared media file according to recorded time information and location information; if media file information is not recorded, the terminal may identify media file content by using an image recognition and analysis algorithm, and select the to-be-shared media file. A current mature technology may be used for the image recognition and analysis algorithm, and details are not described in this embodiment of the present application.

(3) Select, according to a preset sharing condition, a media file matching the preset sharing condition as a to-be-shared media file.

The terminal in this embodiment of the present application may provide a sharing condition as the preset sharing condition. The sharing condition provided by the terminal may be a default sharing condition that is preset by the terminal, or may be determined by the terminal according to a media file attribute stored in a media file library. The media file attribute includes collection time, collection places, media file content, and the like. For example, the terminal parses a photographing time attribute of a media file in the media file library, obtains, by means of parsing, collection time of a batch of media files that are collected lately, and provides these time periods as the sharing condition for a user to perform selection. For example, user A went sightseeing in a scenic area. User A had a trip in a scenic spot from 10:30 a.m. to 12:00 p.m. (in this time period, the first photograph was shot at 10:30 a.m., and the last photograph was shot at 12:00 p.m.), and had a trip in another scenic spot from 14:00 p.m. to 17:00 p.m. If user A wants to share a photograph, two collection time “10:30 a.m. to 12:00 p.m. today” and “14:00 p.m. to 17:00 p.m. today” may be provided for the user to perform selection.

In this embodiment of the present application, a user may select or modify the sharing condition provided by the terminal. A sharing condition obtained after selection or modification by the user is used as the preset sharing condition.

The preset sharing condition in this embodiment of the present application may be temporary. The terminal selects, according to the preset sharing condition, the media file matching the preset sharing condition, so that a special requirement of a user for a media file can be met. For example, the user may select one or more of the following as a to-be-shared media file: a media file whose collection time is in a preset collection time range; a media file whose collection place is the same as a preset collection place; a media file in which a theme of media file content is the same as a preset theme; or a media file whose media file content has been processed. For example, a sharing condition that may be selected or modified and that is used for sharing a media file once may be one or more of the following: different characteristics (for example, beautiful or humorous), different content (for example, a person, an animal, or a landscape), different expressions (for example, a laugh, a cry, or an ugly face), specific time periods (for example, October 1 to 2, or 10:30 a.m. to 12:00 p.m. and 14:00 p.m. to 17:00 p.m. today), specific places or locations (for example, seaside, Shenzhen, or Window of the World), a quantity of media files to be shared (for example, nine), and a processed photograph (for example, facial enhancement processing has been performed).

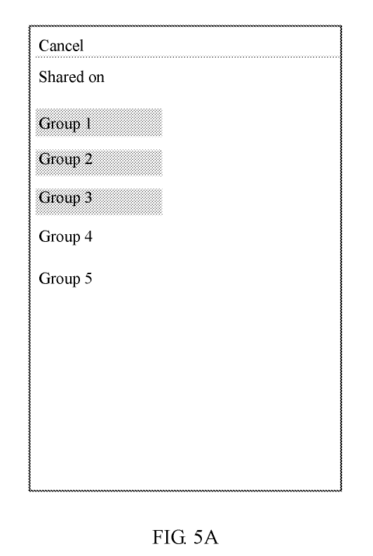

In this embodiment of the present application, the terminal may provide, for a user, an interface used for selecting or modifying the sharing condition provided by the terminal. For example, an interface shown in FIG. 4 may be used. The interface includes a word input area 1, a collection time selection area 2, a collection place selection area 3, a theme selection area 4, and a selection area 5 of a quantity of media files to be shared.

(4) Select, according to words to be shared by a user on the social platform, a media file matching a keyword in the to-be-shared words of the user as a to-be-shared media file.

When sharing a media file, a user usually shares words to express inner feelings. In an implementation manner of this embodiment of the present application, the terminal may parse a keyword in to-be-shared words of the user, and select a media file matching the keyword as a to-be-shared media file.

In an implementable manner, the terminal may parse to-be-shared words of a user into keywords involving time and a place, and keywords related to time and a task, and select a media file matching these keywords. For example, after a user had sightseeing in Shenzhen Bay, if the user wants to share a photograph about an activity on that day, the user only needs to enter to-be-shared words “one-day tour in Shenzhen Bay”. Then, the terminal may obtain, by means of parsing, a photographing place keyword “Shenzhen Bay Park” and a photographing time keyword “the latest day” in the to-be-shared words. In this case, the terminal may select, from a media file library, a media file that includes a place attribute “Shenzhen Bay” and a time attribute “the latest day” as a to-be-shared media file.

(5) Select, according to relevance between media files, an associated media file as a to-be-shared media file.

In this embodiment of the present application, when a to-be-shared media file is being selected, a selected media file may be used as a reference media file, an associated media file associated with the reference media file is selected, and the reference media file and the associated media file are jointly used as to-be-shared media files. In this embodiment of the present application, the reference photograph refers to a selected to-be-shared media file, and the selected to-be-shared media file may be a media file that is selected in any one or more of the manners for selecting a to-be-shared media file that are described in the foregoing Embodiments (1), (2), (3), and (4). The associated media file refers to a media file that has a specified relationship with the reference media file, for example, a media file that has specific relevance to the reference media file in terms of a collection time, a collection place, media file content, and the like. For example, the associated media file may include: a media file whose collection place is the same as that of the reference media file; a media file whose collection time is associated with that of the reference media file, where collection time association includes equivalence of dates, months, or years; and a media file whose subject has a same action, expression, and/or garment as those/that of the reference media file.

In this embodiment of the present application, an associated media file whose collection place is the same as that of the reference media file may be determined by using a media file collection place attribute recorded in a media file, or by determining a background similarity between two media files by using an image analysis algorithm. If the background similarity exceeds a specified threshold, it may be determined that the two media files are collected in a same place.

In this embodiment of the present application, an associated media file whose collection time is associated with that of the reference media file may be determined by using a media file collection time attribute recorded in a media file.

In this embodiment of the present application, an associated media file whose subject has a same action, expression, and/or garment as those/that of the reference media file may be determined by determining, by using an image analysis algorithm, whether subjects of the two media files have a same action, expression, and/or garment. In this embodiment of the present application, the subjects of the reference media file and the associated media file may be a same subject, or may be different subjects. For example, photographs, shot in a same place, of a father and a daughter may be associated photographs, where a subject 1 is the daughter (a user), and a subject 2 is the father (a friend of the user). The subjects of the photographs may be one or more subjects. For example, a group photo, shot at different time, of a mother and a daughter may be associated photographs, where a subject 1 is the mother (a user), and a subject 2 is the daughter (a friend of the user).

A source of the associated media file in this embodiment of the present application may be: a media file in the media file library stored in the terminal; a media file in a cloud media file library for a same user account; a media file that is stored on the social platform by a user or that has been published on the social platform by the user; or a media file that has been published by a friend and that a user has permission to view on a homepage on a social platform of the user.

In this embodiment of the present application, when the terminal selects an associated media file, there is generally one reference media file. If there is more than one selected media file, an associated media file may be determined for each media file.

In this embodiment of the present application, there may be more than one associated media file determined for one reference media file. If there is more than one associated media file for one reference media file, an associated media file of a to-be-shared media file may be determined in one or more of the following manners: In an implementation manner, according to a sequence of collection time, an associated media file whose collection time is farthest from that of the reference media file is used as an associated media file of the to-be-shared media file. For example, on month X date X, year X, user A shot a photograph of user A. If determining, in the manners for selecting a to-be-shared media file that are described in the foregoing Embodiments (1), (2), (3), and (4), that the photograph is a to-be-shared photograph, the terminal uses the photograph as a reference photograph. If it is determined, according to the source of the associated media file in the foregoing embodiment, that there is one or more photographs, shot on month X date X in different years, of user A, a photograph shot in the earliest year is used as an associated photograph.

In another implementation manner, according to a sequence of similarities, an associated media file that has geographic coordinates and collection time (time in one day, such as hour:minute) closest to those of the to-be-shared media file, and that has the largest similarity with the to-be-shared media file in terms of backgrounds, actions, expressions, and/or garments is used as an associated media file of the to-be-shared media file. On month X date X, year X, a photograph is shot for user A in place a. If determining, in the manners for selecting a to-be-shared media file that are described in the foregoing Embodiments (1), (2), (3), and (4), that the photograph is a to-be-shared photograph, the terminal uses the photograph as a reference photograph. If it is determined, according to the source of the associated media file in the foregoing embodiment, that there is one photograph (the photograph may be shot for the father of user A in a same place ten years ago; certainly, a system may not need to determine a subject of the photograph, and the photograph may be shot for user A in a same place ten years ago) whose background similarity with the reference photograph exceeds a specified threshold, the photograph is used as an associated photograph.

In still another implementation manner, according to a sequence of relationships between subjects, relationships between persons in an associated media file is determined by using an image analysis algorithm and a facial recognition technology; and the relationships between persons are sorted according to a sequence of relationships: a user, parents and children, couples or lovers, classmates or friends, and colleagues, and an associated media file in which a relationship between subjects is the closest is used as an associated media file of the to-be-shared media file. For example, user A shot a photograph of user A's daughter. If determining, in the manners for selecting a to-be-shared media file that are described in the foregoing Embodiments (1), (2), (3), and (4), that the photograph is a to-be-shared photograph, the terminal uses the photograph as a reference photograph. If it is determined, according to the source of the associated media file in the foregoing embodiment, that there is one or more photographs that are shot for a same photographed subject who wears a same garment and that meet a sharing quality requirement, a photograph with the highest similarity is used as an associated photograph.

Optionally, in this embodiment of the present application, after selecting, from the local file, the media file satisfying the preset selection condition, when a quantity of selected media files exceeds a specified quantity, the terminal may select, from the selected media files according to a priority sequence that indicates time intervals between collection time and a current time in ascending order, a media file whose quantity is less than or equal to the specified quantity. The specified quantity is less than or equal to a maximum quantity of media files that can be shared by the media file sharing device at a time. According to the implementation solution, the media file sharing device can select media files whose quantity satisfies a sharing quantity, where the media file to be shared is a media file that is collected in a latest time period.

In this embodiment of the present application, the following describes implementation manners for sharing a to-be-shared media file in this embodiment of the present application.

In a possible implementation manner, the terminal in this embodiment of the present application may share the to-be-shared media file to at least one group based on a historical record of sharing a same media file to a group, to share one to-be-shared media file on multiple groups, thereby satisfying a requirement that a user in multiple groups should share one media file on another group of similar nature. For example, user A is in ten different groups, where groups 1 to 3 are groups about hobby a, groups 4 to 6 are groups about hobby b, groups 7 and 8 are colleague groups, and groups 9 and 10 are classmate groups. The terminal determines, by parsing a historical record of sharing a media file by user A, that user A often shares a same media file on several specific groups. For example, hobby a is running, and each time user A shares, to a group 1, a media file about running, user A shares the same media file on the groups 2 and 3. In this case, the terminal may share a to-be-shared media file of user A on the groups 1, 2, and 3 according to the historical record of sharing a media file by user A.

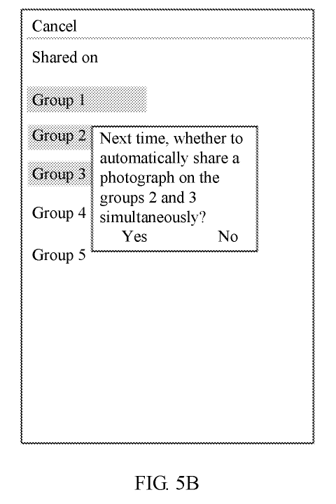

In this embodiment of the present application, the terminal may provide, for a user, a graphical interface for sharing a to-be-shared media file on multiple groups. For example, when user A shares a determined to-be-shared media file on the group 1, the terminal provides, for user A, a graphical interface for sharing the to-be-shared media file on the groups 2 and 3 simultaneously. As shown in FIG. 5A, user A may select, on a media file sharing display interface, a group (a group 1, a group 2, a group 3, a group 4, or a group 5) on which a to-be-shared media file is to be shared. If user A chooses to share a to-be-shared media file on the group 1, the groups 2 and 3 are also selected. In this embodiment of the present application, a graphical interface for determining whether to share a to-be-selected media file on the groups 2 and 3 simultaneously may be further provided for user A, as shown in FIG. 5B.

In another possible implementation manner, the terminal may parse content of the to-be-shared media file, determine a word description matching the content of the to-be-shared media file, and share the to-be-shared media file and the word description matching the content of the to-be-shared media file. In this way, a process of entering a word description by a user is omitted, which improves sharing efficiency. For example, if learning, by parsing content of a to-be-shared media file, that a scenario in the media file is riding a bicycle in Shenzhen Bay, the terminal may automatically match a word description “xxx has a one-day tour in Shenzhen Bay xxx” for the to-be-shared media file, and share both the to-be-shared media file and the matched word description.

In still another possible implementation manner, in this embodiment of the present application, a manner for displaying a media file on a media file sharing display interface may be selected.

In an implementation manner, different media files may be respectively displayed in different display areas on a media file sharing display interface. For example, if to-be-shared media files are nine videos, each video may be respectively displayed in each of 3x3 areas.

In another implementation manner, different media files may be displayed in a same display area on a media file sharing display interface by means of scrolling. For example, all media files may be played in one display area sequentially.

According to the foregoing method, in this embodiment of the present application, the terminal can select and share a to-be-shared media file, and complete selection and sharing of the media file without user's participation; therefore, sharing efficiency is relatively high.

In this embodiment of the present application, a cycle for selecting a to-be-shared media file by the terminal may be set. The terminal detects, in the specified cycle according to the manners provided in the foregoing embodiment, a media file that is suitable for being selected as a to-be-shared media file, and shares the media file.

In this embodiment of the present application, after detecting a trigger operation used for triggering media file sharing, the terminal may alternatively perform an implementation procedure for selecting and sharing a to-be-shared media file.

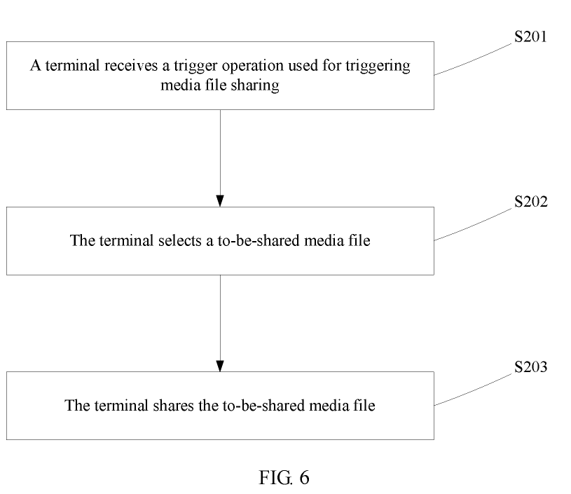

FIG. 6 is a flowchart of another implementation for sharing a media file by a terminal according to an embodiment of the present application. As shown in FIG. 6, the implementation procedure includes the following steps.

S201: The terminal receives a trigger operation used for triggering media file sharing.

In this embodiment of the present application, a trigger operation used for triggering media file sharing may be performed in one of the following several trigger manners. In an implementable manner, a trigger operation may be triggered by a user. For example, by tapping a social application that is used for sharing a media file and that is on a display interface of the terminal, a user triggers the terminal to select a to-be-shared media file; or a user may select, at an entry of a sharing interface used by the terminal to perform media file sharing, a function menu for automatically selecting a media file. In another implementable manner, a trigger operation may be triggered by the terminal. For example, if the terminal detects that there is a newly collected media file in a media library, the terminal may be triggered to select, from the newly collected media file, a media file as a to-be-shared media file; or if the terminal detects that there is a media file matching a current place of the terminal in a media library of the terminal, the terminal may be triggered to select the media file matching the current place of the terminal as a to-be-shared media file. In still another implementable manner, a trigger operation may be triggered by a social platform on which a media file is published. For example, if a user is to share words on the social platform, the social platform may trigger the terminal to select a media file matching a keyword in the to-be-shared words as a to-be-shared media file.

S202: Select a to-be-shared media file.

S203: Share the to-be-shared media file.

In this embodiment of the present application, S202 and S203 are respectively the same as S101 and S102 that are described in the foregoing embodiment, and details are not described herein again.

In this embodiment of the present application, to avoid a problem in the foregoing method that during a process of selecting a to-be-shared media file, the terminal selects a media file that a user does not like, based on the method procedure shown in FIG. 3 or FIG. 6, the method in this embodiment of the present application may further include: detecting, by the terminal, a deletion instruction of a user for deleting a media file from the to-be-shared media file selected by the terminal, and deleting, from the selected to-be-shared media file, the media file indicated by the deletion instruction.

In this embodiment of the present application, based on the method shown in FIG. 6, that a deletion instruction is detected and a selected media file is deleted is used as an example for description in the following.

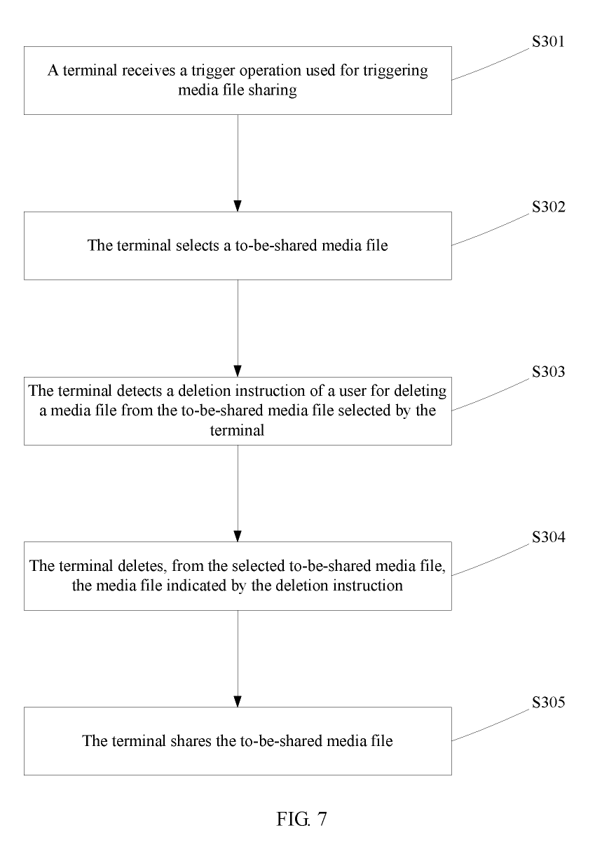

FIG. 7 is a flowchart of still another implementation for sharing a media file according to an embodiment of the present application. In FIGS. 7, S301 and S302 are respectively the same as S201 and S202 in FIG. 6, S305 is the same as S203 in FIG. 6, and details are not described herein again. The following only describes differences thereof.

S303: The terminal detects a deletion instruction of a user for deleting a media file from the to-be-shared media file selected by the terminal.

In this embodiment of the present application, although the terminal selects media files of relatively high quality according to the media file selection method in the foregoing embodiment, these media files may not be media files that a user actually wants to share. In this case, the user may delete the to-be-shared media files selected by the terminal. For example, a user shot three photographs: a one-person photograph A for a user's friend, a two-person photograph A′ for a user's friend and another person, and a many-person photograph A″ for a user's friend and other persons. The terminal selects the photograph A″ in which a quantity of persons is the largest as a to-be-shared photograph. However, the user actually wants to select the one-person photograph A as a to-be-shared photograph. In this case, the user may delete the photograph A″ selected by the terminal.

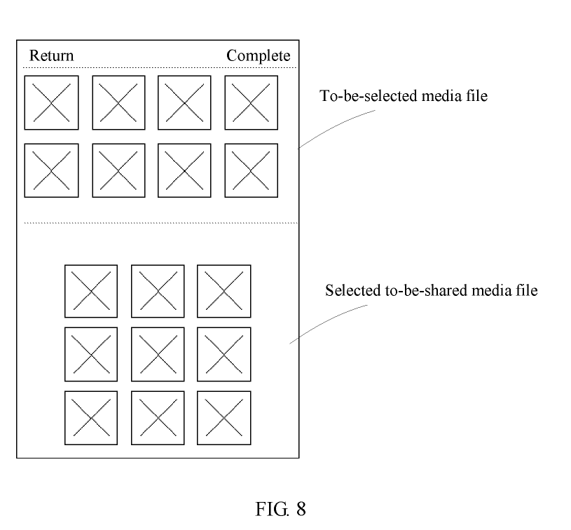

In this embodiment of the present application, the terminal may provide, for a user, a preview interface for a selected to-be-shared media file, as shown in FIG. 8. The preview interface shown in FIG. 8 includes the selected to-be-shared media file and a to-be-selected media file. In this embodiment of the present application, the terminal may provide, for a user and on the preview interface, a function for deleting some selected to-be-shared media files, for example, display a cross or subtraction sign (not shown in the figure) in an upper right corner of each to-be-shared media file. Certainly, some selected to-be-shared media files may alternatively be deleted in another manner, which is not limited in this embodiment of the present application. For example, a media file that needs to be deleted is pressed hard, and then the media that needs to be deleted is slid upwards (or in other direction), so as to leave an area in which the selected to-be-shared media file is located. In this way, the corresponding media file is deleted.

S304: The terminal deletes, from the selected to-be-shared media file, the media file indicated by the deletion instruction.

In this embodiment of the present application, after deleting, from the selected to-be-shared media file, the media file indicated by the deletion instruction, the terminal may further reselect a media file as a to-be-shared media file. The reselected media file used as a to-be-shared media file may be a media file associated with the deleted media file, or may be a media file that is selected by the terminal and that is not used as a to-be-shared media file. For example, in the foregoing example, if the user deletes the photograph A″ selected by the terminal, the terminal may reselect, from the multiple media files A, A′, and A″ with a same theme, a to-be-shared media file to be shared.

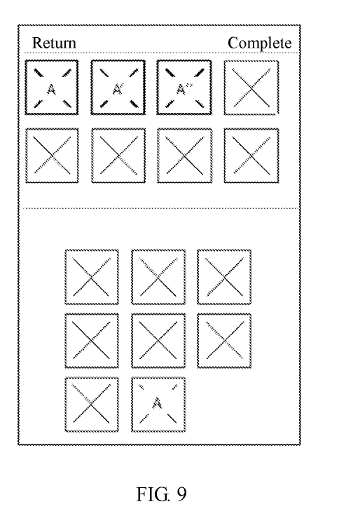

In this embodiment of the present application, there may be multiple media files reselected by the terminal, and a user selects a to-be-shared media file that is to be shared finally. Optionally, the terminal may recommend, to a user, a media file that may be used as a to-be-shared media file, and prompt the user with the media file. There may be multiple prompt manners. For example, in FIG. 9, in an area of to-be-selected media files, for the photographs A, A′, and A″, sizes are scaled up, colors are lightened, colored line boxes are added, and the like. In this embodiment of the present application, for ease of description, thick lines are used for identification in FIG. 9.

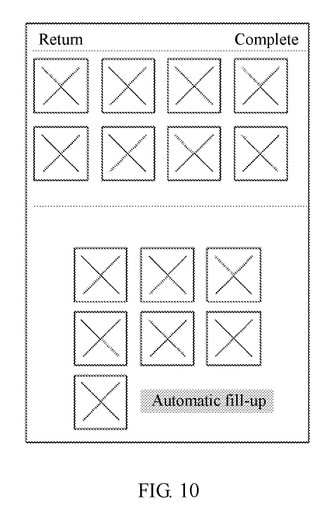

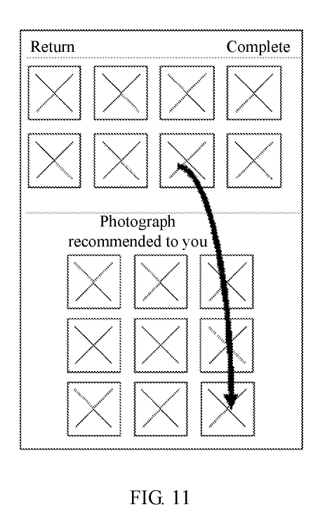

In this embodiment of the present application, the terminal may display, in a place of a deleted media file, “automatic fill-up” or an operable prompt (for example, “+”) of a similar function, as shown in FIG. 10. After a user performs an operation (for example, a tap), a new media file is added, as shown in FIG. 11. In this embodiment of the present application, during a process of adding a new media file, animation of selecting a media file from to-be-selected photographs as a selected to-be-shared media file may be displayed, including a sound effect and/or a moving track of a photograph, and the like. In this way, a feedback provided by the terminal for a user is enhanced, and user experience is improved.

In this embodiment of the present application, if a quantity of to-be-shared media files selected by the terminal is less than a maximum quantity of media files that can be shared by a social platform at a time, the terminal may provide, for a user, a graphical interface for adding a media file.

In this embodiment of the present application, to avoid a problem in the foregoing method that during a process of selecting and sharing a to-be-shared media file, the terminal shares a media file that a user does not like, based on the method procedure shown in FIG. 3, FIG. 6, or FIG. 7, the method in this embodiment of the present application may further include: before sharing the to-be-shared media file, detecting a confirmation instruction for the user to confirm sharing of the to-be-shared media file.

In this embodiment of the present application, based on the method shown in FIG. 7, that a confirmation instruction for the user to confirm sharing of the to-be-shared media file is used as an example for description.

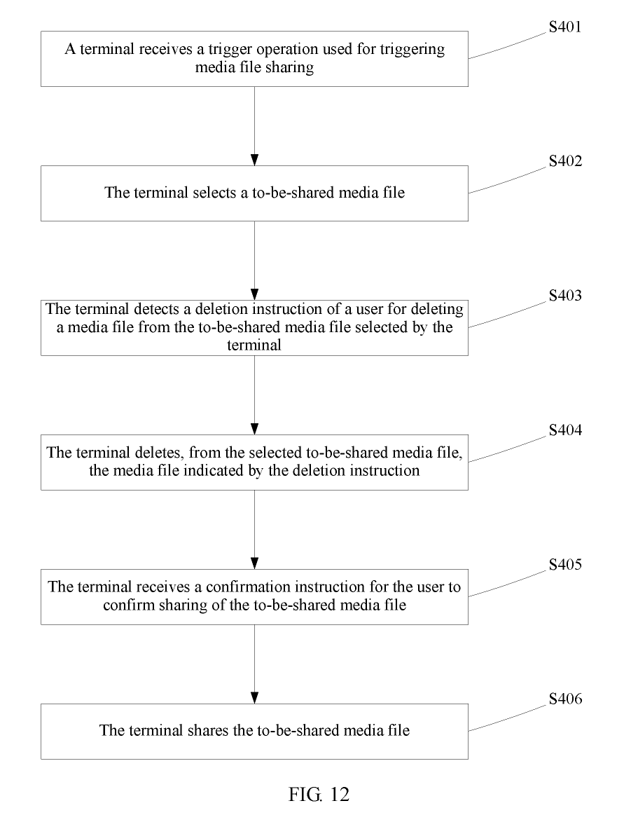

FIG. 12 is a flowchart of yet another implementation for sharing a media file according to an embodiment of the present application. In FIG. 12, S401, S402, S403, and S404 are respectively the same as S301, S302, S303, and S304 in FIG. 7, S406 is the same as S305 in FIG. 7, and details are not described herein again. The following only describes differences thereof.

S405: The terminal receives a confirmation instruction for the user to confirm sharing of the to-be-shared media file.

In this embodiment of the present application, the terminal may provide manual confirmation for the user, for example, provide a graphical interface for a user to choose whether to confirm sharing of a to-be-selected media file. If the user chooses to confirm sharing of the to-be-shared media file, the user shares the to-be-shared media file.

Based on the media file sharing methods provided in the foregoing method embodiments, an embodiment of the present application further provides a media file sharing device. The media file sharing device has all functions for implementing the foregoing media file sharing methods.

In this embodiment of the present application, the functions for performing the foregoing media file sharing methods by the media file sharing device may be implemented by means of hardware, or may be implemented by hardware executing corresponding software.

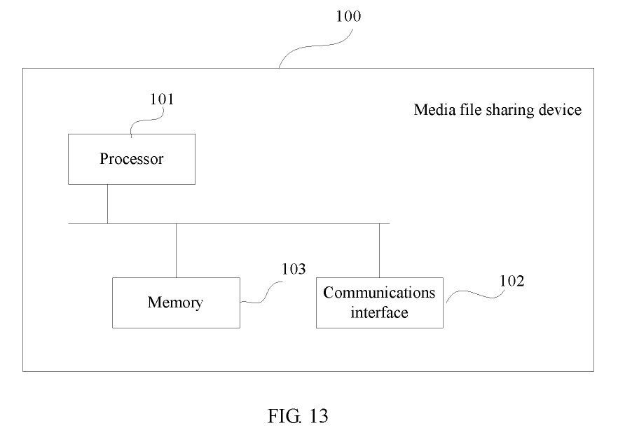

FIG. 13 is a schematic structural diagram of a media file sharing device according to an embodiment of the present application. A media file sharing device 100 includes a processor 101 and a communications interface 102.

The processor 101 is configured to have all functions for performing the foregoing media file sharing methods, such as determining a preset selection condition, selecting, from a local file, a media file satisfying the preset selection condition as a to-be-shared media file, and sharing the to-be-shared media file. The communications interface 102 is configured to perform a communication function during a process of sharing the media file. The media file sharing device 100 may further include a memory 103, where the memory 103 is configured to be coupled to the processor 101, and the memory 103 stores a program instruction and data that are required for the media file sharing device.

In this embodiment of the present application, the hardware or software for performing the media file sharing method by the media file sharing device includes one or more modules corresponding to the foregoing functions. The module may be software and/or hardware.

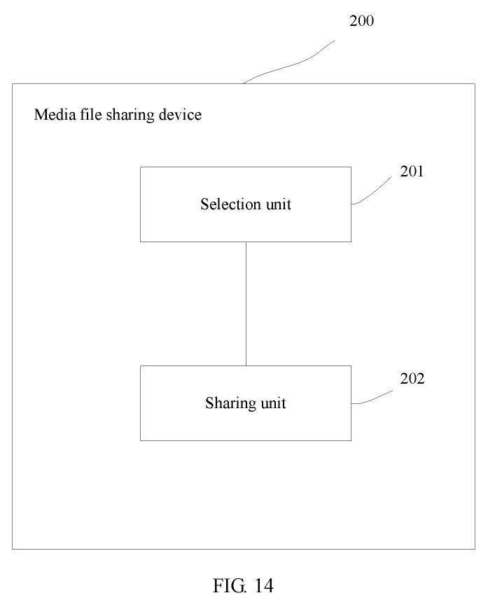

FIG. 14 is another schematic structural diagram of a media file sharing device according to an embodiment of the present application. As shown in FIG. 14, the media file sharing device 200 includes a selection unit 201 and a sharing unit 202. The selection unit 201 is configured to: determine a preset selection condition; and select, from a local file, a media file satisfying the preset selection condition as a to-be-shared media file. The sharing unit 202 is configured to share the to-be-shared media file selected by the selection unit 201.

The selection unit 201 may select, in the following manners, the media file satisfying the preset selection condition. In an implementable manner, a media file that has a preset association relationship with a current place of the media file sharing device is selected. In another implementable manner, a media file that has a preset association relationship with media file content is selected.

In this embodiment of the present application, the selection unit 201 is further configured to:

after selecting, from the local file, the media file satisfying the preset selection condition, when a quantity of selected media files exceeds a specified quantity, select, from the selected media files according to a priority sequence that indicates time intervals between collection time and a current time in ascending order, a media file whose quantity is less than or equal to the specified quantity, where the specified quantity is less than or equal to a maximum quantity of media files that can be shared by the media file sharing device at a time.

The selection unit 201 is further configured to:

before the sharing unit 202 shares the to-be-shared media file, when detecting a deletion instruction of a user for deleting a media file from the to-be-shared media file selected by the media file sharing device, delete, from the selected to-be-shared media file, the media file indicated by the deletion instruction.

The selection unit 201 is further configured to:

after deleting, from the selected to-be-shared media file, the media file indicated by the deletion instruction, when a media file that is added by the user is obtained, use a selected to-be-shared media file that is not deleted and the media file that is added by the user as to-be-shared media files.

The selection unit 201 is further configured to: before selecting the to-be-shared media file, receive a trigger operation used for triggering media file sharing.

In this embodiment of the present application, the sharing unit 202 may share the to-be-shared media file to at least one group based on a historical record of sharing a same media file to a group.

In this embodiment of the present application, the sharing unit 202 may further parse content of the to-be-shared media file, determine a word description matching the content of the to-be-shared media file, and share the to-be-shared media file and the word description matching the content of the to-be-shared media file.

The sharing unit 202 is further configured to: before sharing the to-be-shared media file, receive a confirmation instruction for the user to confirm sharing of the to-be-shared media file.

Optionally, the media file sharing device 100 and the media file sharing device 200 in the embodiments of the present application may include a terminal and a social platform, so as to implement all functions in the media file sharing methods described in the foregoing method embodiments. For a specific implementation process of the functions, refer to the related descriptions of the foregoing method embodiments. Details are not described herein again.

An embodiment of the present application further provides a computer storage medium, which is configured to store a computer software instruction used by the foregoing media file sharing device and includes a program used for the media file sharing device in the foregoing embodiment.

According to the media file sharing method and the media file sharing device that are provided in the embodiments of the present application, a media file can be selected instead of manual selection by a user, which improves media file sharing efficiency.

A person of ordinary skill in the art may understand that all or a part of the steps in each of the foregoing method of the embodiments may be implemented by a program instructing a processor. The foregoing program may be stored in a computer readable storage medium. The storage medium may be a non-transitory (English: non-transitory) medium, such as a random-access memory, read-only memory, a flash memory, a hard disk, a solid state drive, a magnetic tape (English: magnetic tape), a floppy disk (English: floppy disk), an optical disc (English: optical disc), or any combination thereof.

The present application is described with reference to the flowcharts and/or block diagrams of the method and the device according to the embodiments of the present application. It should be understood that computer program instructions may be used to implement each process or each block in the flowcharts or the block diagrams and a combination of a process and a block in the flowcharts and the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and in one or more blocks in the block diagrams.

The foregoing descriptions are merely examples of implementation manners of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A media file sharing method, comprising:
determining, by a processor of a terminal, a preset selection condition;
selecting, from a local file, one or more media files satisfying the preset selection condition as a to-be-shared media file; and
sharing the to-be-shared media file.

2. The method according to claim 1, wherein the preset selection condition comprises selecting a media file that has a preset association relationship with a current place of a media file sharing device.

3. The method according to claim 1, wherein the preset selection condition comprises selecting a media file that has a preset association relationship with media file content.

4. The method according to claim 1, wherein after the selecting, from the local file, the one or more media files satisfying the preset selection condition, the method further comprises:
when a quantity of selected media files exceeds a specified quantity, selecting, from the selected media files according to a priority sequence that indicates time intervals between collection time and current time in ascending order, a media file whose quantity is less than or equal to the specified quantity, wherein
the specified quantity is less than or equal to a maximum quantity of media files that can be shared by the media file sharing device at a time.

5. The method according to claim 1, wherein the sharing the to-be-shared media file comprises:
sharing the to-be-shared media file to at least one group based on a historical record of sharing a same media file to a group.

6. The method according to a claim 1, wherein the sharing the to-be-shared media file comprises:
parsing content of the to-be-shared media file, and determining a word description matching the content of the to-be-shared media file; and
sharing the to-be-shared media file and the word description matching the content of the to-be-shared media file.

7. The method according to claim 1, wherein before the sharing the to-be-shared media file, the method further comprises:
when a deletion instruction of a user for deleting a media file from the to-be-shared media file selected by the media file sharing device is detected, deleting, from the selected to-be-shared media file, the media file indicated by the deletion instruction.

8. The method according to claim 7, wherein after the deleting, from the selected to-be-shared media file, the media file indicated by the deletion instruction, the method further comprises:
when a media file that is added by the user is obtained,
using a selected to-be-shared media file that is not deleted and the media file that is added by the user as to-be-shared media files.

9. The method according to claim 1, wherein before the sharing the to-be-shared media file, the method further comprises:
receiving a confirmation instruction for the user to confirm sharing of the to-be-shared media file.

10. The method according to claim 1, wherein before the determining a preset selection condition, the method further comprises:
receiving a trigger operation used for triggering media file sharing.

11. A media file sharing device, comprising:
a processor configured to:
determine a preset selection condition; and
select, from a local file, a media file satisfying the preset selection condition as a to-be-shared media file; and
a communication interface coupled to the processor and configured to share the to-be-shared media file.

12. The media file sharing device according to claim 11, wherein the processor is further configured to select a media file satisfying the preset selection condition by
selecting a media file that has a preset association relationship with a current place of the media file sharing device; or,
selecting a media file that has a preset association relationship with media file content.

13. The media file sharing device according to claim 11, wherein the processor is further configured to:
after selecting, from the local file, the media file satisfying the preset selection condition, when a quantity of selected media files exceeds a specified quantity, select, from the selected media files according to a priority sequence that indicates time intervals between collection time and current time in ascending order, a media file whose quantity is less than or equal to the specified quantity, wherein
the specified quantity is less than or equal to a maximum quantity of media files that can be shared by the media file sharing device at a time.

14. The media file sharing device according to claim 11, wherein the processor is further configured to share the to-be-shared media file to at least one group based on a historical record of sharing a same media file to a group.

15. The media file sharing device according to claim 11, wherein the to-be-shared media file is shared by
parsing content of the to-be-shared media file, and determining a word description matching the content of the to-be-shared media file; and
sharing the to-be-shared media file and the word description matching the content of the to-be-shared media file.

16. The media file sharing device according to claim 11, wherein the processor is further configured to:
before the sharing unit shares the to-be-shared media file, when detecting a deletion instruction of a user for deleting a media file from the to-be-shared media file selected by the media file sharing device, delete, from the selected to-be-shared media file, the media file indicated by the deletion instruction.

17. The media file sharing device according to claim 11, wherein the processor is further configured to:
after deleting, from the selected to-be-shared media file, the media file indicated by the deletion instruction, when a media file that is added by the user is obtained, use a selected to-be-shared media file that is not deleted and the media file that is added by the user as to-be-shared media files.

18. The media file sharing device according to claim 11, wherein the processor is further configured to:
before sharing the to-be-shared media file, receive a confirmation instruction for the user to confirm sharing of the to-be-shared media file.

19. The media file sharing device according to claim 11, wherein the processor is further configured to:
before selecting the to-be-shared media file, receive a trigger operation used for triggering media file sharing.

20. A non-transitory computer-readable medium storing computer instructions, that when executed by one or more processors, cause the one or more processors to perform the step of:
determining a preset selection condition;
selecting, from a local file, one or more media files satisfying the preset selection condition as a to-be-shared media file; and
sharing the to-be-shared media file.
